(19) United States
(12) Patent Application Publication
(10) Pub. No.: US 2021/0383475 A1
(43) Pub. Date: Dec. 9, 2021

(54) COMPUTER-READABLE RECORDING MEDIUM STORING TRANSACTION PROGRAM, TRANSACTION METHOD, AND TRANSACTION DEVICE

(71) Applicant: FUJITSU LIMITED, Kawasaki-shi (JP)

(72) Inventors: Toshihiro Shimizu, Kawasaki (JP); Akihito Nakamura, Shinagawa (JP); Motohiro KOSAKI, Kawasaki (JP); Akihiro Kuwabara, Meguro (JP)

(73) Assignee: FUJITSU LIMITED, Kawasaki-shi (JP)

(21) Appl. No.: 17/409,913

(22) Filed: Aug. 24, 2021

Related U.S. Application Data
(63) Continuation of application No. PCT/JP2019/009198, filed on Mar. 7, 2019.

(51) Int. Cl. G06Q 40/04; G06Q 40/02; G06Q 40/06

(52) U.S. Cl. CPC G06Q 40/04; G06Q 40/06; G06Q 40/02

(57) ABSTRACT

A non-transitory computer-readable recording medium stores a transaction program for causing a computer to execute processing including: acquiring a selling limit and buying limit for each contract; creating, on the basis of a difference between the acquired selling limit and a next transaction price and a difference between the next transaction price and the acquired buying limit, a dissatisfaction function that represents dissatisfaction of an investor for each contract with the next transaction price as a variable; mating a total dissatisfaction function for all contracts on the basis of the dissatisfaction function created for each contract; and determining the next transaction price on the basis of a value of the created total dissatisfaction function.

### CROSS-REFERENCE TO RELATED APPLICATION

This application is a continuation application of International Application PCT/JP2019/009198 filed on Mar. 7, 2019 and designated the the entire contents of which are incorporated herein by reference.

### FIELD

The embodiments discussed her in ate related to a transaction program, a transaction method, and a transaction device.

### BACKGROUND

In transactions of stocks or the like, there are Itayose and a continuous session. The Itayose is a transaction in which orders are collected from a time an order is received to a start of trading, and an opening price is determined after the trading is completed. The continuous session is a transaction in which trading is completed between an order already placed and an order newly placed, or between orders newly placed.

Japanese National Publication of International Patent Application No. 2001-522487 and Japanese Laid-open Patent Publication No. 2007-122592 are disclosed as related art.

### SUMMARY

According to an aspect of the embodiments, a non-transitory computer-readable recording medium stores a transaction program for causing a computer to execute processing including: acquiring a selling limit and buying limit for each contract; creating, on the basis of a difference between the acquired selling limit and a next transaction price and a difference between the next transaction price and the acquired buying limit, a dissatisfaction function that represents dissatisfaction of an investor for each contract with the next transaction price as a variable; creating a total dissatisfaction function for all contracts on the basis of the dissatisfaction function created for each contract; and determining the next transaction price on the basis of a value of the created total dissatisfaction function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of Itayose by a contract device according to an embodiment;

FIG. 2 is a diagram for describing a definition of dissatisfaction of investors;

FIGS. 3A and 3B are diagrams illustrating examples of an activation function A(d);

FIGS. 4A and 4B are diagrams illustrating examples of a dissatisfaction function DC(q);

FIG. 5 is a diagram illustrating an example of a dissatisfaction summation function;

FIG. 6 is a diagram illustrating configuration of a transaction system according to the embodiment;

FIG. 7A is a diagram for describing a maximum flow problem of a network flow;

FIG. 7B is a diagram for describing formulation of a board as a network flow;

FIG. 7C is a diagram illustrating a maximum flow of the network flow illustrated in FIG. 7B;

FIG. 8 is a flowchart illustrating a flow of processing by the contract device;

FIG. 9 is a flowchart illustrating a flow of processing by a matching unit;

FIG. 10 is a flowchart illustrating a flow of processing by a next price determination unit;

FIG. 11 is a flowchart illustrating a flow of processing of specifying the next stock price by using a golden section search;

FIG. 12 is a flowchart illustrating a flow of processing of calculating a value of DS(q);

FIG. 13 is a diagram illustrating a hardware configuration of a computer that executes a contract program according to the embodiment;

FIG. 14 is a diagram illustrating an example of board information in a stock transaction; and

FIG. 15 is a diagram for describing the Itayose in the stock transaction.

### DESCRIPTION OF EMBODIMENTS

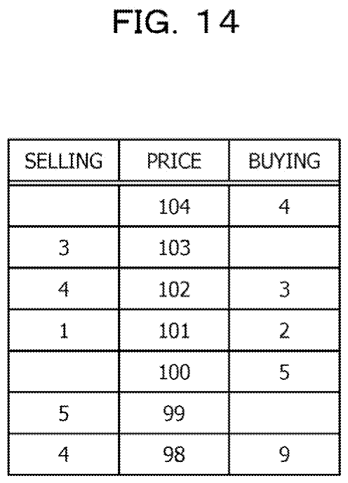

A transaction uses board information indicating a selling limit of a selling order and the number of selling orders and a buying limit of a buying order and the number of buying orders. FIG. 14 is a diagram illustrating an example of board information in a stock transaction. In FIG. 14, a middle column indicates a limit price, a left column indicates the number of selling orders corresponding to the price, and a right column indicates the number of buying orders corresponding to the price, Here, 1 is a unit stock number. For example, the number of selling orders with a selling limit of 102 yen is 4, and the number of buying orders with a buying limit of 102 yen is 3.

In the Itayose in a stock transaction, a contract device contracts selling orders and buying orders in order, in ascending order of a price of the selling order and in descending order of a price of the buying order. Then, the contract device stops the contract when a selling order and a buying order have the same price, and sets the price at this time as a current price. In addition, all the contracted transactions are performed at the current price.

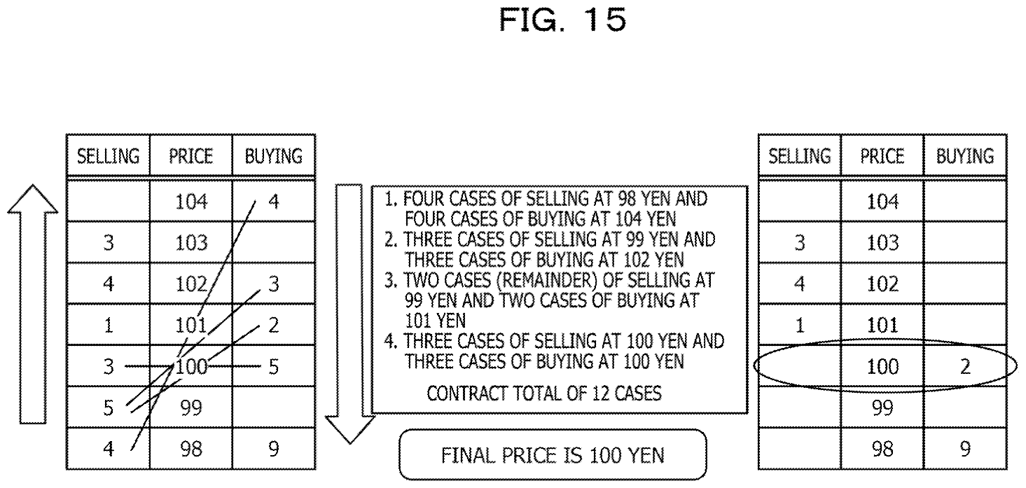

FIG. 15 is a diagram for describing the Itayose in the stock transaction. As illustrated in FIG. 15, the contract device first contracts four cases of selling at 98 yen and four cases of buying at 104 yen. Next, the contract device contracts three cases of selling at 99 yen and three cases of buying at 102 yen. Next, the contract device contracts two cases of selling at 99 yen and two cases of buying at 101 yen. Then, the contract device contracts three cases of selling at 100 yen and three cases of buying at 100 yen, and ends the contract. In this case, the contract device contracts a total of 12 cases for 100 yen, and the current price is set to 100 yen.

Note that, as a prior art, there is a system that performs a linked transaction by a method of optimizing a transaction price for both parties involved in the transaction. Here, the linked transaction is a plurality of securities transactions computerized in individual simultaneous transactions. The system includes a linked transaction workstation, a plurality of transactor workstations, and a central control engine.

A linked transactor uses the linked transaction workstation to input a satisfaction density profile that defines a degree of satisfaction to transact a plurality of securities simultaneously on the basis of an overall cost of the transaction. Individual securities transactors use the transactor workstation to input a satisfaction density profile that indicates a degree of satisfaction to transact specific securities as a function of price/volume.

The central control engine determines a satisfaction density function for each of individual securities on the basis of input of the transactor, and determines a joint satisfaction function for all securities from individual satisfaction density functions. Then, the central control engine determines a mutual satisfaction function from the joint satisfaction function and the satisfaction density profile input by the linked transactor, and maximizes the mutual satisfaction function to establish a set of prices, volumes, and parties for transacting each of the individual securities. The central control engine further executes simultaneously a transaction among the identified parties for a plurality of securities at the established prices and volumes.

Furthermore, as a prior art, there is a system that supports setting of an optimum bidding price that maximizes an expected value of profit in a spot market of products. In this system, a past time series data acquisition unit acquires a spot price past time series data contracted in the spot market in the past. Furthermore, a profit calculation data acquisition unit acquires production cost data or retail price data as profit calculation data for calculating an expected value of a profit index.

Then, a time series analysis unit analyzes the spot price past time series data to generate a time series of a one-period predicted value of a past spot price (predicted price time series) and a time series of a standard deviation or variance of a predicted error between the one-period predicted value and a one-period actual value. Then, a bidding price optimization unit uses the predicted price time series, the time series of the standard deviation or variance of the predicted error, and the production cost data or retail price data to calculate an optimum bidding price that maximizes an expected value of a preset profit index for a selling transaction and buying transaction.

In the Itayose illustrated in FIG. 15, a selling order with a price higher than the current price, a buying order with a price lower than the current price, and either a selling order with the current price or a buying order with the current price are held without being settled. Thus, the held orders remain on a board, and the number of contracts is small. Thus, it is conceivable to increase the number of contracts by making a contract regardless of a current price when a price is more favorable to investors than a limit price. Here, the favorable price is a price higher than the limit price for a selling order and a price lower than the limit price for a buying order. However, by making a contract regardless of a current price when a price is more favorable to investors than a limit price, a contract price is different for each contract Thus, the issue is how to determine the next stock price.

In one aspect, the embodiments discussed herein determine the next stock price in a case where there is a plurality of contract prices in Itayose.

Hereinafter, embodiments of a transaction program, a transaction method, and a transaction device that are disclosed in the present application will be described in detail with reference to the drawings. Note that the embodiments do not limit the technology disclosed.

### Embodiments

First, an Itayose method by a contract device according to an embodiment will be described. The contract device according to the embodiment makes a contract regardless of a current price when a price is a limit price or is more favorable to investors than the limit price.

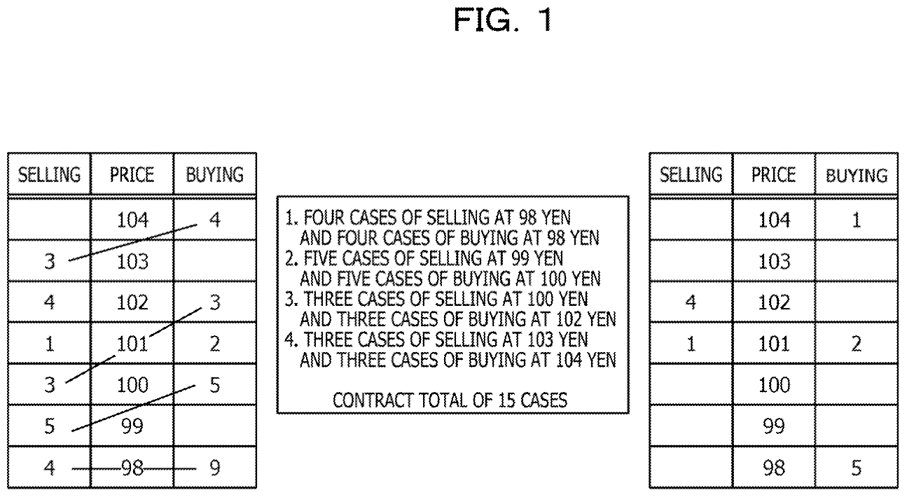

FIG. 1 is a diagram illustrating an example of Itayose by the contract device according to the embodiment. As illustrated in FIG. 1, the contract device according to the embodiment contracts a total of 15 cases, including four cases of selling at 98 yen and four cases of buying at 98 yen, five cases of selling at 99 yen and five cases of buying at 100 yen, three cases of selling at 100 yen and three cases of buying at 102 yen, and three cases of selling at 103 yen and three cases of buying at 104 yen. Compared with the case illustrated in FIG. 15, in the Itayose method by the contract device according to the embodiment, the number of contracts increases by three cases.

As described above, in the Itayose by the contract device according to the embodiment, since there is a degree of freedom in which selling order and which buying order are to be contracted, it is possible to select a contract method such as maximizing the number of contracts and minimizing a difference in a contract price. Furthermore, in the Itayose by the contract device according to the embodiment, when it is assumed that the next stock price is q yen, the contract price is set to a price dose to q yen in a section between a limit price of a seller and a limit price of a buyer.

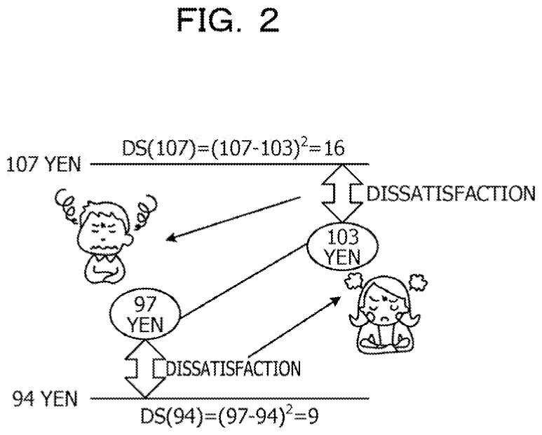

Furthermore, the contract device according to the embodiment quantifies dissatisfaction of investors by using the next stock price, and determines the next stock price as a price that minimizes the dissatisfaction of investors. FIG. 2 is a diagram for describing a definition of the dissatisfaction of investors. In FIG. 2, selling at 97 yen and buying at 107 yen are contracted.

In the case of g<97, a contract price is 97 yen. In this case, a seller is not dissatisfied because a selling price has exceeded a limit price. On the other hand, a buyer is dissatisfied because the next stock price of q yen is lower even though a buying price has been 97 yen. The larger a difference (97−q), the greater the dissatisfaction of the buyer. For example, when the difference² is defined as a dissatisfaction function DC(q), in the case of q=94, DC(94)=(97−94)²=9 is the dissatisfaction of the buyer.

In the case pf 97≤q≤103, since the contract price and the next stock price are equal, neither the seller nor the buyer is dissatisfied,

In the case of 103<q, the contract price is 103 yen. In this case, the seller is dissatisfied because the next stock price of q yen is higher even though a selling price has been 103 yen. The larger a difference (q−103), the greater the dissatisfaction of the seller. On the other hand, the buyer is not dissatisfied because a buying price has been equal to or lower than the limit price. For example, when the difference² is defined as the dissatisfaction function DC(q), in the case of q=107, DC(107)=(107−103)²=16 is the dissatisfaction of the seller.

Thus, the contract device according to the embodiment uses an activation function A(d), which is a function for returning dissatisfaction according to a difference d, a selling limit of s yen, and a buying limit of b yen, to define the dissatisfaction function DC(q) as

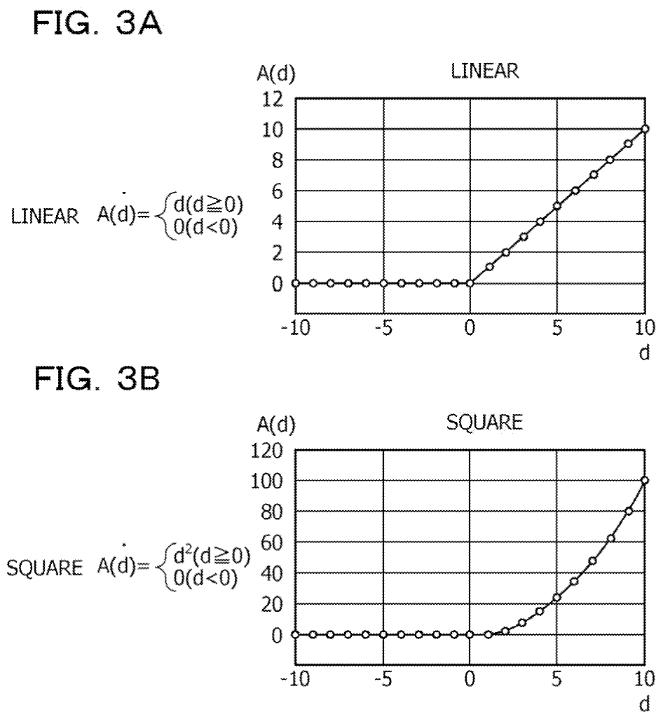

Dc(q)=A(s−q)+A(q−b). FIGS. 3A and 3B are diagrams illustrating examples of the activation function A(d). FIG. 3A illustrates a case where the activation function A(d) is linear, and FIG. 3B illustrates a case where the activation function A(d) is square.

As illustrated in FIG. 3A, A(d)=d in the case of d≥0, and A(d)=0 in the case of d<0. Furthermore, as illustrated in FIG. 3B, A(d)=d² in the case of d□0, and A(d)=0 in the case of d<0.

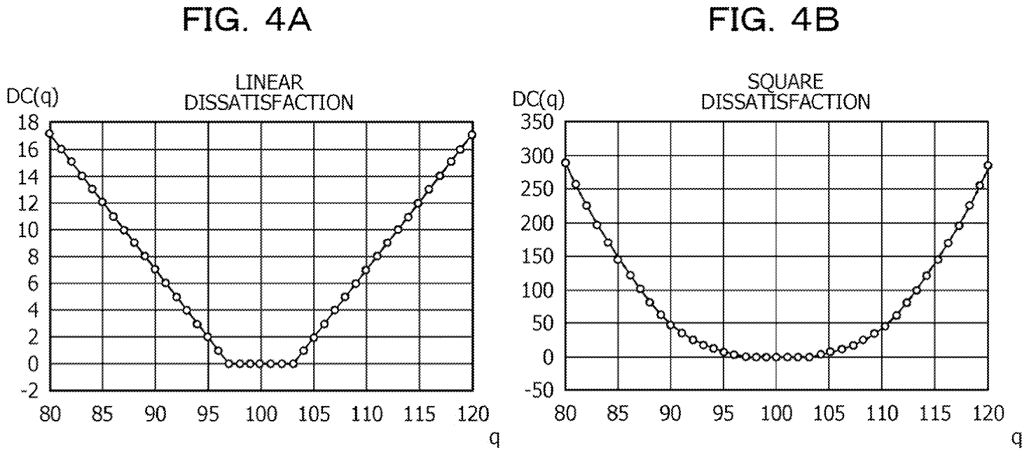

FIGS. 4A and 4B are diagrams illustrating examples of the dissatisfaction function DC(q). In FIGS. 4A and 4B, s=97 and b=103. FIG. 4A illustrates a case where a linear activation function is used, and FIG. 4B illustrates a case where a square activation function is used. As illustrated in FIGS. 4A and 4B, a dissatisfaction function is a convex function that is convex downward.

Then, the contract device according to the embodiment defines a dissatisfaction summation function DCS(q) for the next stock price of q yen as

DCS(q)=ΣDCᵢ(q),

and specifies q that minimizes DCS(q). Here, DCᵢ(q) is the dissatisfaction function in a contract i. DCS(q) is a function that is convex downward.

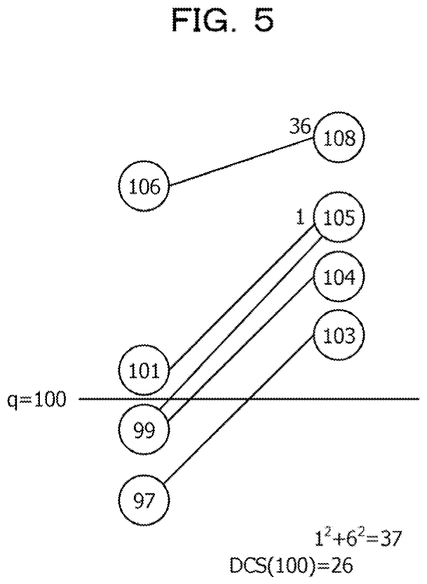

FIG. 5 is a diagram illustrating an example of the dissatisfaction summation function. As illustrated in FIG. 5, when it is assumed that q=100, a buyer is dissatisfied with two contracts of selling at 101 yen and buying at 105 yen, and selling at 106 yen and buying at 108 yen, and DCS(100)=1²+6²=37. Note that, in this example, a square is used for the activation function A(d).

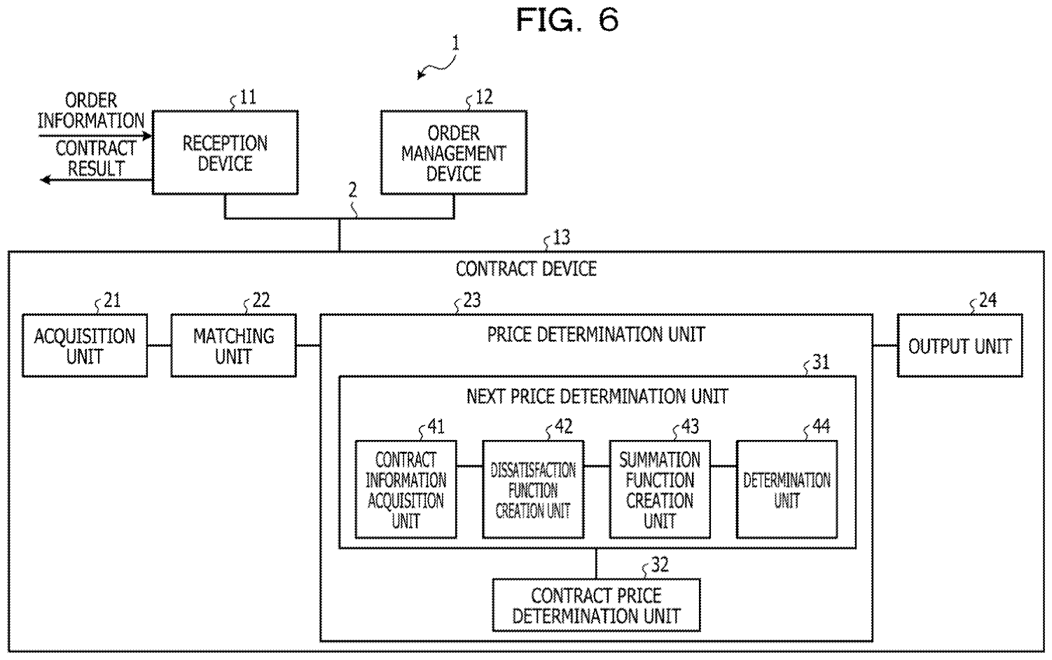

Next, a configuration of a transaction system according to the embodiment will be described. FIG. 6 is a diagram illustrating the configuration of the transaction system according to the embodiment. As illustrated in FIG. 6, a transaction system 1 according to the embodiment includes a reception device 11, an order management device 1, and a contract device 13. The reception device 11, the order management device 12, and the contract device 13 are connected by an internal network 2.

The reception device 11 receives order information and transmits the order information to the order management device 12. Examples of the order information include an orderer identifier that identifies an orderer, a brand, a distinction between buying and selling, a limit price, and the number of stocks. The reception device 11 receives, for example, order information transmitted from an information processing device via an external network. The information processing device transmits the order information on the basis of, for example, an order input by an investor by using a mouse or a keyboard.

Furthermore, the reception device 11 receives a contract result from the order management device 12 and transmits the contract result to the information processing device. Examples of the contract result include an orderer identifier, a brand, a distinction between buying and selling, a contract price, and the number of contract stocks. The reception device 11 transmits the contract result to the information processing device which is a transmission source of the order information, for example, by using an Internet Protocol (IP) address associated with the orderer identifier.

The order management device 12 manages order information by, for example, adding an order identifier that identifies an order. The order management device 12 stores all pieces of order information received by the reception device 11 by a start of the Itayose, and at the start of the Itayose, transmits, for each brand, a selling limit and the number of selling orders, and a buying limit and the number of buying orders to the contract device 13.

Furthermore, the order management device 12 receives, for each brand, contract information from the contract device 13, and updates the order information. Furthermore, the order management device 12 creates a contract result on the basis of the contract information, and transmits the contract result to the reception device 11. Examples of the contract information include, for one or more contracts, a selling it, a buying limit, a contract price, and the number of contract stocks.

In the Itayose, the contract device 13 receives, for each brand, information regarding a selling order and a buying order from the order management device 12 via the internal network 2, contracts the selling order and the buying order, and determines a contract price and the next stock price. Each piece of the information regarding a selling order includes a selling limit and the number of selling orders, and each piece of the information regarding a buying order includes a buying limit and the number of buying orders. Furthermore, the contract device 13 transmits, for each brand, contract information to the order management device 12 via the internal network 2.

The contract device 13 includes an acquisition unit 21, a matching unit 22, a price determination unit 23, and an output unit 24. The acquisition unit 21 receives, for each brand, information regarding a selling order and buying order from the order management device 12 via the internal network 2.

The matching unit 22 matches, for each brand, a selling order and a buying order The matching unit 22 performs matching regardless of a current price when a price is a limit price or is more favorable to investors than the limit price. The matching unit 22 maximizes the number of matches by formulating a board as a network flow.

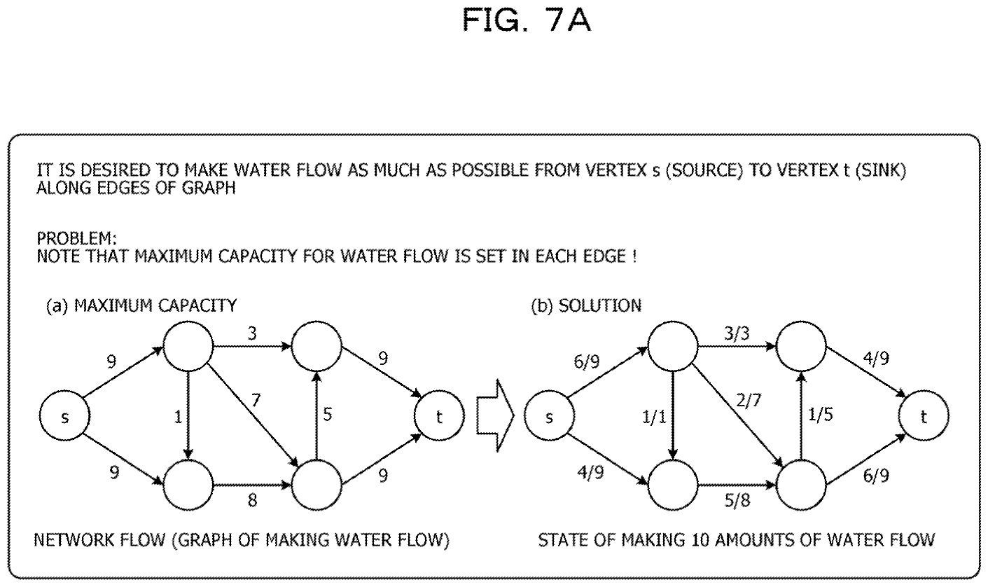

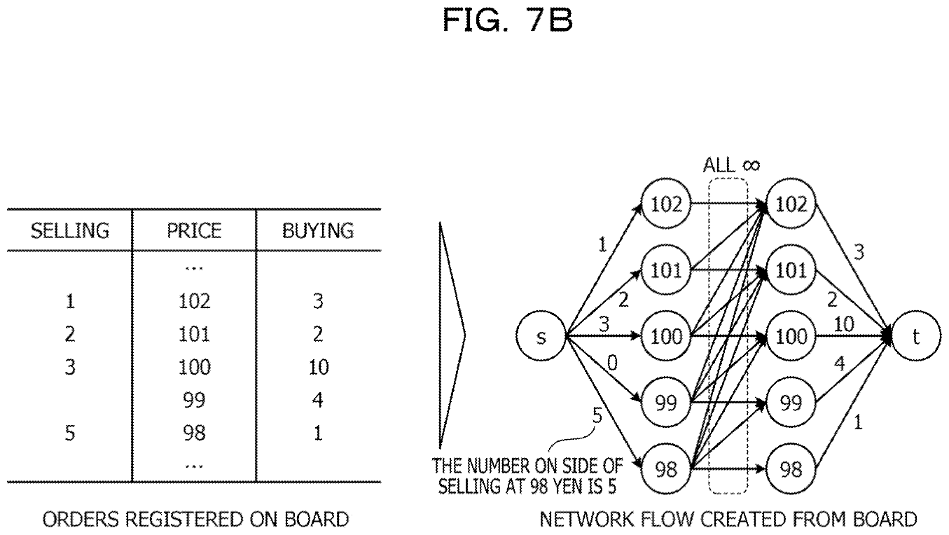

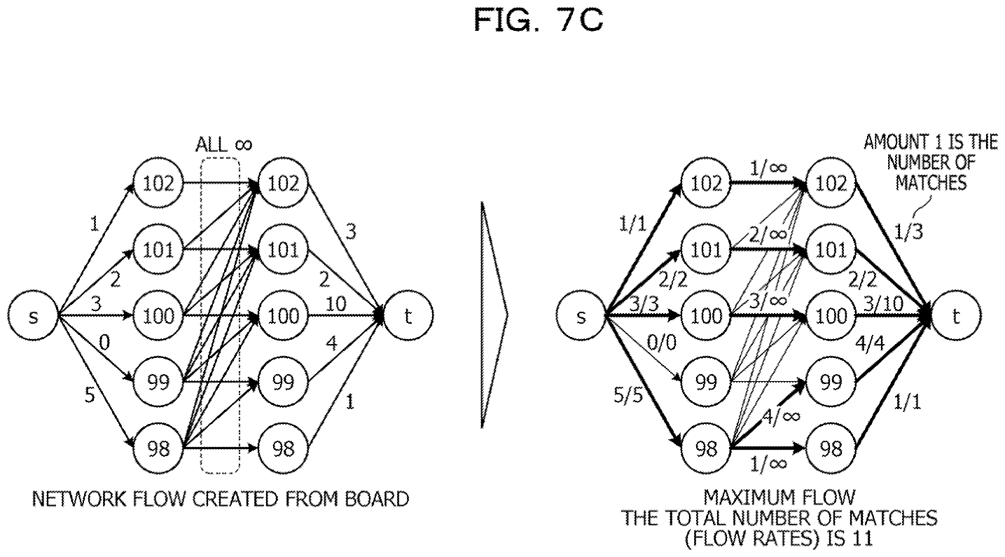

FIG. 7A is a diagram for describing a maximum flow problem of a network flow. As illustrated in FIG. 7A, the maximum flow problem is a problem of determining to which edge and how much amount of water needs to be made to flow in order to make water flow as much as possible from a vertex s (source) to a vertex t (sink) along edges of a graph. Note that, as illustrated in (a) of FIG. 7A, a maximum capacity for water flow is set in each edge., A solution is illustrated in (b) of FIG. 7A, where a denominator is the capacity and a numerator is a flow rate in a fraction of each edge. In (b) of FIG. 7A, a maximum amount of water 10 flows from s to t.

FIG. 7B is a diagram for describing formulation of the board as a network flow. AS illustrated in FIG. 7B, the matching unit 22 creates vertexes according to s (source), t (sink), a selling limit, and a buying limit. Then, the matching unit 22 sets a capacity between a selling vertex and a buying vertex to ∞ (no restriction), sets a capacity of an edge from s to the selling vertex to the number of selling orders at the selling limit of the selling vertex, and sets a capacity of an edge from the buying vertex to t to the number of buying orders at the buying limit of the buying vertex.

In FIG. 7B, a capacity of an edge from s to a selling vertex of 98 yen is 5, a capacity of an edge from s to a selling vertex of 99 yen is 0, and a capacity of an edge from s to a selling vertex of 100 yen is 3. Furthermore, a capacity of an edge from s to a selling vertex of 101 yen is 2, and a capacity of an edge from s to a selling vertex of 102 yen is 1.

Similarly, a capacity of an edge from a buying vertex of 98 yen to t is 1, a capacity of an edge from a buying vertex of 99 yen to t is 4, and a capacity of an edge from a buying vertex of 100 yen to t is 10. Furthermore, a capacity of an edge from a buying vertex of 101 yen to t is 2, and a capacity of an edge from a buying vertex of 102 yen to t is 3.

FIG. 7C is a diagram illustrating a maximum flow of the network flow illustrated in FIG. 7B. In FIG. 7C, a flow rate of each edge indicates the number of matches, and the total number of matches is 11. For example, a total of 11 cases are matched, including one case of selling at 98 yen and one case of buying at 98 yen, four cases of selling at 98 yen and four cases of buying at 99 yen, three cases of selling at 100 yen and three cases of buying at 100 yen, two cases of selling at 101 yen and two cases of buying at 101 yen, and one case of selling at 102 yen and one case of buying at 102 yen.

The matching unit 22 uses algorithms such as Hopcroft-Karp, Dinic, and Edmonds-Karp as algorithms for solving the maximum flow problem. When it is assumed that the number of vertexes is V and the number of edges is E, a calculation amount of Hopcroft-Karp is O(E√V), a calculation amount of Dinic is O(V²E), and a calculation amount of Edmonds-Karp is O(VE²).

Note that the matching unit 22 may use a matching method other than formulating as the maximum flow problem of the network flow. For example, the matching unit 22 may match a selling order and a buying order by performing matching by all searches. For example, the matching unit 22 creates a list A of j cases of selling orders and a list B of j cases of buying orders. Then, the matching unit 22 selects one combination of the j cases of A and the j cases of B, and performs, for all j cases, recording processing of recording, as a matching candidate, a combination in which a selling limit is equal to or lower than a buying limit. The matching unit 22 executes the recording processing for all combinations while changing the combinations of the j cases of A and the j cases of B. Moreover, the matching unit 22 executes the recording processing for all combinations of A and B while changing A or B. Moreover, the matching unit 22 performs the recording processing while changing the number of matches j from 1 to u. Here, u is the smaller one of the number of selling orders and the number of buying orders.

Then, the matching unit 22 selects an optimum matching from the matching candidates. Here, the optimum matching means, for example, an average of selling limits is the lowest, an average of buying limits is the highest, the number of matches is the largest, and there are a few matches between the same securities companies.

Alternatively, the matching unit 22 may perform matching by randomly selecting a selling order and a buying order. For example, the matching unit 22 creates a list A of j cases of selling orders and a list B of j cases of buying orders. Then, the matching unit 22 randomly selects one case from each of A and B to determine a selling limit is equal to or lower than a buying limit, and performs, for all j cases of A and B, recording processing of recording, as a matching candidate, a combination which the selling limit is equal to or lower than the buying limit. The matching unit 22 executes the recording processing for all combinations of A and B while changing A or B. Moreover, the matching unit 22 performs the recording processing while changing the number of matches j from 1 to u. Then, the matching unit 22 selects an optimum matching from the matching candidates.

Alternatively, the matching unit 22 may perform matching by a branch and bound method. For example, the matching unit 22 performs a depth-first search in matching a selling order and a buying order, and when determining that it is not possible to obtain an optimum matching even when a deeper search is performed at a certain search point, does not perform the deeper search.

Alternatively, the matching unit 22 may use a genetic algorithm to match a selling order and a buying order. For example, the matching unit 22 determines mating rules for two matching plans, mates the two matching plans according to the mating rules, and creates a next-generation matching plan. The matching unit 22 creates a better matching plan by repeating the creation of the next-generation matching plan. The matching unit 22 creates, for example, a matching plan for thousands of generations.

Alternatively, the matching unit 22 may use a binary search to specify the maximum number of contracts k, and match k selling orders from a selling order with the lowest price with k buying orders from a buying order with the highest price. Alternatively, the matching unit 22 may use a bipartite graph to specify the maximum number of contracts k.

The price determination unit 23 determines, on the basis of matching by the matching unit 22, a contract price for each matching and the next stock price for each brand. The pace determination unit 23 includes a next price determination unit 31 and a contract price determination unit 32.

The next price determination unit 31 determines the next stock price. The next price determination unit 31 includes a contract information acquisition unit 41, a dissatisfaction function creation unit 42, a summation function creation unit 43, and a determination unit 44.

The contract information acquisition unit 41 acquires, for ail contracts (matches), a selling limit and buying limit for each contract from e matching unit 22.

The dissatisfaction function creation unit 42 creates a dissatisfaction function DC(q) for each contract by using the selling limit and buying limit acquired by the contract information acquisition unit 41, the next stock price of q yen, and an activation function A(d).

The summation function creation unit 43 creates a dissatisfaction summation function DCS(q) by adding, for all contracts, a dissatisfaction function DC(g) created for each contract by the dissatisfaction function creation unit 42.

The determination unit 44 specifies a value qₘᵢₙ of q, which minimizes a value of a dissatisfaction summation function DCS(q), and sets the next stock once as qₘᵢₙ yen. The determination unit 44 uses, for example, a golden section search to specify qₘᵢₙ. Since the determination unit 44 may calculate DCS(_{d}) corresponding to q by only looking at the entire board once, dₘᵢₙ may be specified by O(NlogN). Note that the determination unit 44 may use a binary search or a quadrant search.

When it is assumed that a selling limit is s yen, a buying limit is b (s≤b) yen, the next stock price is q yen, and a value close to q in a section [s, b] is r, the contract price determination unit 32 sets the contract price to r yen. For example, the contract price determination unit 32 determines the contract price on the basis of the next stock price.

The output unit 24 transmits, for each brand, contract information to the order management device 12 via the internal network 2.

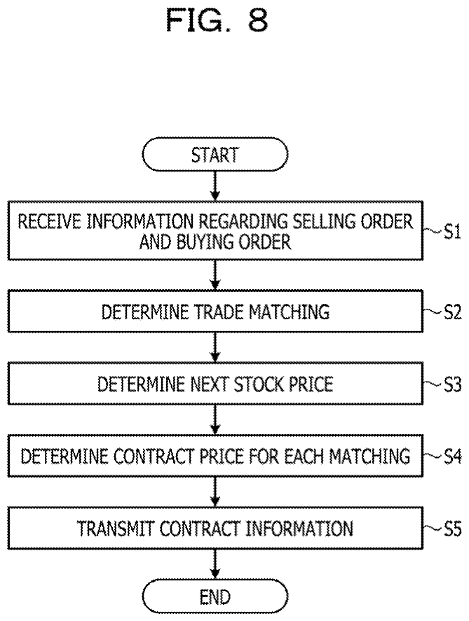

Next, a flow of processing by the contract device 13 will be described. FIG. 8 is a flowchart illustrating the flow of the processing by the contract device 13. Note that the contract device 13 performs the processing illustrated in FIG. 8 for each brand. As illustrated in FIG. 8, at the start of the Itayose, the contract device 13 receives information regarding a selling order and buying order from the order management device 32 (Step S1).

Then, the contract device 13 determines trade matching (Step S2). The contract device 13 performs matching regardless of a current price when a price is a limit price or is more favorable to investors than the limit price. Then, the contract device 13 determines the next stock price (Step S3), and determines a contract price for each matching (Step S4). Then, the contract device 13 transmits contract information to the order management device 12 (Step S5).

As described above, the contract device 13 performs matching regardless of the current price when the price is the limit price or is more favorable to investors than the limit price, and determines the contract price for each matching. Thus, the number of contracts may be increased.

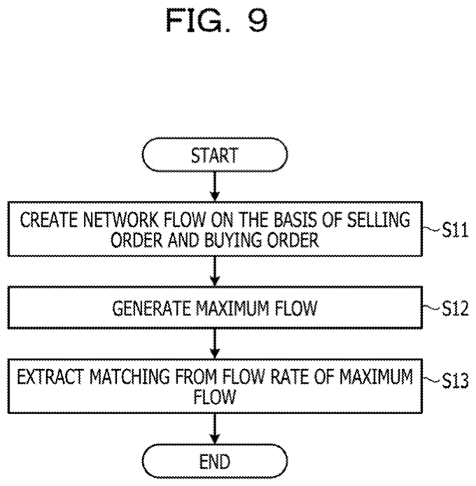

FIG. 9 is a flowchart illustrating a flow of processing by the matching unit 22. As illustrated in FIG. 9, the matching unit 22 creates a network flow on the basis of a selling order and a buying order (Step S11). Then, the matching unit 22 generates a maximum flow (Step S12), and extracts matching from a flow rate of the maximum flow (Step S13).

As described above, the matching unit 22 may specify matching with the maximum number of matches by formulating the board as a network flow.

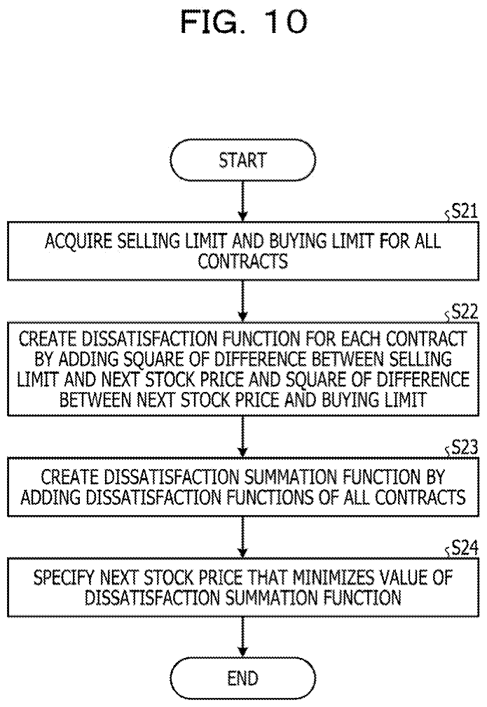

FIG. 10 is a flowchart illustrating a flow of processing by the next price determination unit 31. Note that, here, the case will be indicated where a square is used as an activation function. As illustrated in FIG. 10, the next price determination unit 31 acquires, from the matching unit 22, a selling limit and buying limit for all contracts (Step S21). Then, the next price determination unit 31 creates a dissatisfaction function for each contract by adding a square of a difference between the selling limit and the next stock price and a square of a difference between the next stock price and the buying limit (Step S22).

Then, the next price determination unit 31 creates a dissatisfaction summation function by adding the dissatisfaction functions of all contracts (Step S23), and specifies the next stock price that minimizes a value of the dissatisfaction summation function (Step S24).

As described above, the next price determination unit 31 specifies the next stock price that minimizes the value of the dissatisfaction summation function. Thus, dissatisfaction with the next stock price of investors may be minimized.

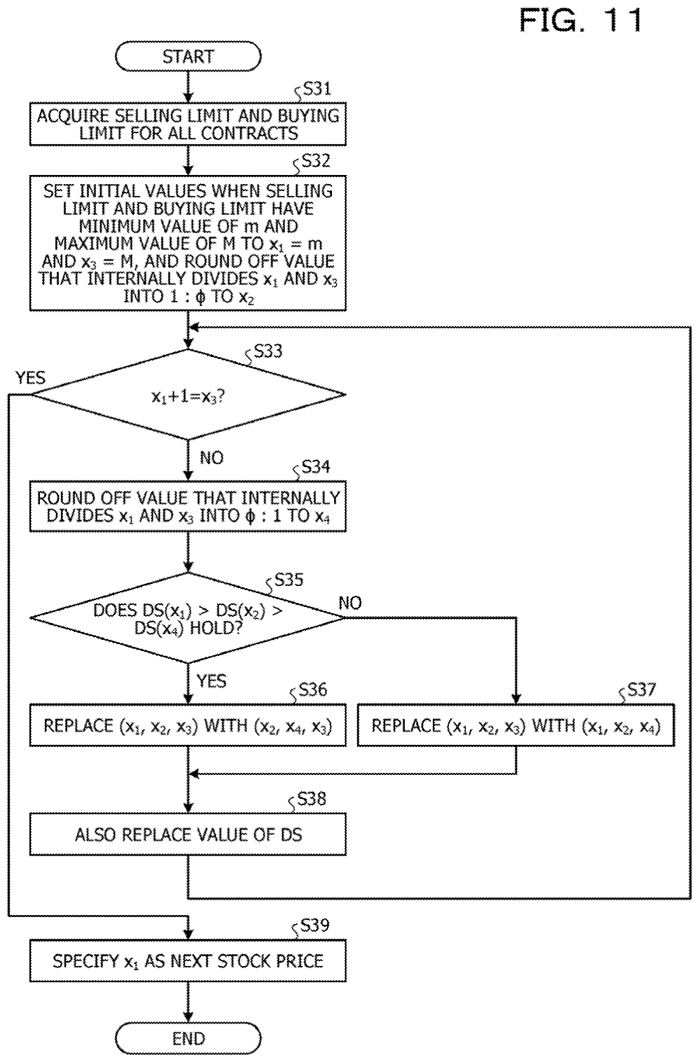

Note that, it is also possible to directly specify the next stock price that minimizes the value of the dissatisfaction summation function without creating the dissatisfaction function and the dissatisfaction summation function. Therefore, a flow of processing of directly specifying the next stock price that minimizes the value of the dissatisfaction summation function by using the golden section search will be described. FIG. 11 is a flowchart illustrating the flow of the processing of specifying the next stock price by using the golden section search.

As illustrated in FIG. 11, the next price determination unit 31 acquires a selling limit and buying limit for all contracts (Step S31). Then, the next price determination unit 31 sets initial values when the selling limit and buying limit have a minimum value of m and a maximum value of M to x₁=m and x₃=M, and rounds off a value that internally divides x₁ and x₃ into 1:φ to x₂ (Step S32). Here, φ is a golden ratio ((1+√5)/2).

Then, the next price determination unit 31 determines whether Or not x₁+1 and x₃ are equal (Step S33), and in a case where x₁+1 and x₃ are not equal, rounds off a value that internally divides x₁ and x₃ into φ:1 to x₄ (Step S34). Then, the next price determination unit 31 determines whether or not DS(x₁)>DS(x₂)>DS(x₄) holds (Step S35), and in a case where DS(x₁)>DS(x₂)>DS(x₄) holds, replaces (x₁, x₂, x₃) with (x₂, x₄, x₃) (Step S36). On the other hand, in a case where DS(x₁)>DS(x₂)>DS(x₄) does not hold, the next price determination unit 31 replaces (x₁, x₂, x₃) with (x₁, x₂, x₄) (Step S37). Then, the next price determination unit 31 also replaces a value of DS (Step S38), and returns to Step S33.

In Step S33, in a case where x₁+1 and x₃ are equal, the next price determination unit 31 specifies x₁ as the next stock price (Step S39).

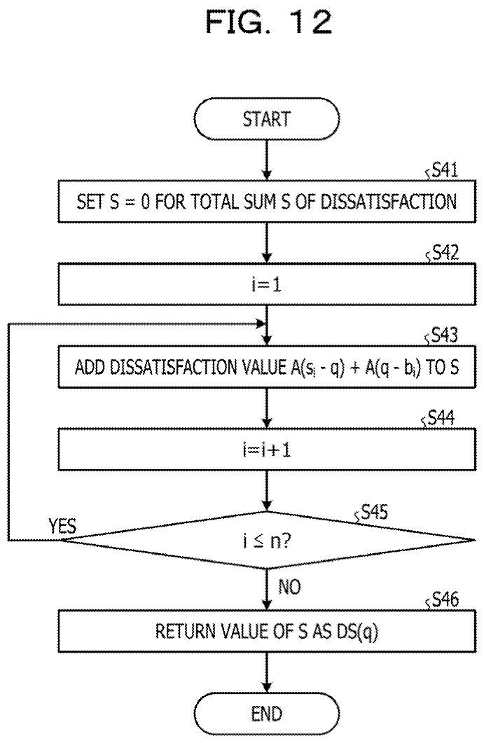

FIG. 12 is a flowchart illustrating a flow of processing of calculating a value of DS(q). As illustrated in FIG. 12, the next price determination unit 31 sets S=0 (Step S41) for the total sum S of dissatisfaction and i=1 for a contract i (Step S42). Then, the next price determination unit 31 adds a dissatisfaction value A(sᵢ−q)+A(q−bᵢ) of the contract to S (Step S43), and sets i=i+1 (Step S44).

Then, the next price determination unit 31 determines whether or not i is equal to or lower than n (Step S45). Here, n is the number of contracts. Then, the next price determination unit 31 returns to Step S43 in a case where i is equal to or lower than n, and returns a value of S as DS(q) in a case where i is not equal to or lower than n (Step S46).

As described above, the next price determination unit 31, uses the golden section search to directly specify the next stock price that minimizes the value of the dissatisfaction summation function. Thus, it is possible to efficiently specify the next stock price.

As described above, in the embodiment, the contract information acquisition unit 41 acquires a selling limit and buying limit for each contract, and the dissatisfaction function creation unit 42 creates a dissatisfaction function for each contract on the basis of a difference between the selling limit and the next stock price and a difference between the next stock price and the buying limit. Then, the summation function creation unit 43 creates a dissatisfaction summation function for all contracts on the basis of the dissatisfaction function for each contract, and the determination unit 44 determines the next stock price on the basis of the dissatisfaction summation function. Therefore, the contract device 13 may determine the next stock price on the basis of dissatisfaction of investors.

Furthermore, in the embodiment, the dissatisfaction function creation unit 42 may use a square as an activation function when creating the dissatisfaction function. Thus, the larger the dissatisfaction, the larger the increase in the dissatisfaction function may become.

Furthermore, in the embodiment, the determination unit 44 specifies the next stock price that minimizes a value of the dissatisfaction summation function. Thus, the contract device 13 may minimize the dissatisfaction of investors.

Note that, in the embodiment, the contract device 13 has been described. However, by implementing the configuration of the contract device 13 by software, it is possible to obtain a contract program that has a similar function. Therefore, a computer that executes the contract program will be described.

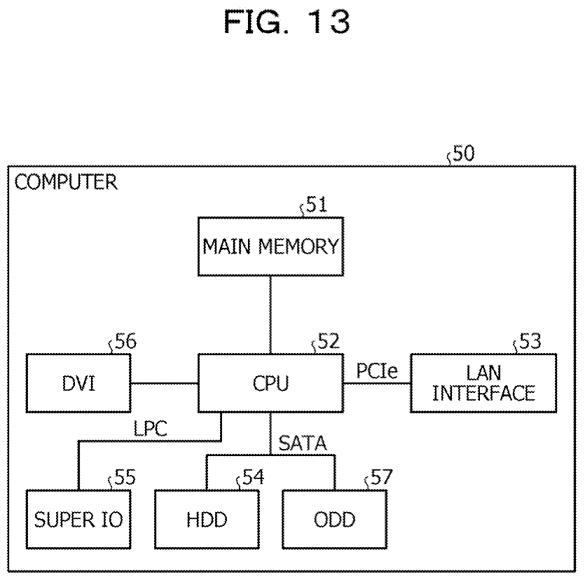

FIG. 13 is a diagram illustrating a hardware configuration of the computer that executes the contract program according to the embodiment. As illustrated in FIG. 13, a computer 50 includes a main memory 51, a central processing unit (CPU) 52, a local area network (LAN) interface 53, and a hard disk drive (HDD) 54. Furthermore, the computer 50 includes a super input output (IO) 55, a digital visual interface (DVI) 56, and an optical disk drive (ODD) 57.

The main memory 51 is a memory that stores a program, a halfway result of execution of the program, and the like. The CPU 52 is a central processing unit that reads a program from the main memory 51 and executes the program. The CPU 52 includes a chipset having a memory controller.

The LAN interface 53 is an interface for connecting the computer 50 to another computer via a LAN. The HDD 54 is a disk device that stores a program and data, and the super IO 55 is an interface for connecting an input device such as a mouse and a keyboard. The DVI 56 is an interface for connecting a liquid crystal display device, and the ODD 57 is a device that reads and writes data from and to a digital versatile disc (DVD).

The LAN interface 53 is connected to the CPU 52 by peripheral component interconnect express (PCIe), and the HDD 54 and the ODD 57 are connected to the CPU 52 by serial advanced technology attachment (SATA). The super IO 55 is connected to the CPU 52 by low pin count (LPC).

Then, the contract program executed by the computer 50 is stored in a DVD that is an example of a recording medium that may be read by the computer 50, and is read from the DVD by the ODD 57 to be installed to the computer 50. Alternatively, the contract program is stored in a database or the like of another computer system connected via the LAN interface 53 and is read from the database or the like and is installed to the computer 50. Then, the installed contract program is stored in the HDD 54, read to the main memory 51, and executed by the CPU 52.

Furthermore, in the embodiment, the case has been described where the transaction system 1 includes the reception device 11, the order management device 12, and the contract device 13. However, the functions of the reception device 11, the order management device 12, and the contract device 13 may be combined into one to constitute a transaction device. Alternatively, optional two functions may be combined into one to constitute one device, such as combining the functions of the reception device 11 and the order management device 12 into one.

Furthermore, in the embodiment, the case transacting stocks has been described. However, the transaction system 1 may transact other securities and goods.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a transaction program for causing a computer to execute processing comprising:
acquiring a selling limit and buying limit for each contract;
creating, ort the basis of a difference between the acquired selling limit and a next transaction price and a difference between the next transaction price and the acquired buying limit, a dissatisfaction function that represents dissatisfaction of an investor for each contract with the next transaction price as a variable;
creating a total dissatisfaction function for all contracts on the basis of the dissatisfaction function created for each contract; and
determining the next transaction price on the basis of a value of the created total dissatisfaction function.

2. The non-transitory computer-readable recording medium storing a transaction program according to claim 1, wherein the dissatisfaction function is a sum of the difference between the acquired selling limit and the next transaction price and the difference between the next transaction price and the acquired buying limit.

3. The non-transitory computer-readable recording medium storing a transaction program according to claim 1, wherein the dissatisfaction function is a sum of a square of the difference between the acquired selling limit and the next transaction price and a square of the difference between the next transaction price and the acquired buying limit.

4. The non-transitory computer readable recording medium storing a transaction program according to claim 1, wherein the total dissatisfaction function is a total sum of the dissatisfaction function created for each contract.

5. The non-transitory computer-readable recording medium storing a transaction program according to claim 1, wherein, in the processing of determining the next transaction price, a value that minimizes the value of the total dissatisfaction function is set as the next transaction price.

6. The non-transitory computer-readable recording medium storing a transaction program according to claim 5, wherein, in the processing of determining the next transaction price, the value that minimizes the value of the total dissatisfaction function is specified by using a golden section search.

7. A transaction method comprising:
acquiring a selling limit and buying limit for each contract;
creating, on the basis of a difference between the acquired selling limit and a next transaction price and a difference between the next transaction price and the acquired buying limit, a dissatisfaction function that represents dissatisfaction of an investor for each contract with the next transaction price as a variable;
creating a total dissatisfaction function for all contracts on the basis of the dissatisfaction function created for each contract; and
determining the next transaction price on the basis of a value of the created total dissatisfaction function.

8. The transaction method according to claim 7, wherein the dissatisfaction function is a sum of a square of the difference between the acquired selling limit and the next transaction price and a square of the difference between the next transaction price and the acquired buying limit.

9. The transaction method according to claim 7, wherein, in a processing of determining the next transaction price, a value that minimizes the value of the total dissatisfaction function is set as the next transaction price.

10. An information processing device comprising:
a memory; and
a processor coupled to the memory and configured to:
acquire a selling limit and buying limit for each contract;
create, on the basis of a difference between the acquired selling limit and a next transaction price and a difference between the next transaction price and the acquired buying limit, a dissatisfaction function that represents dissatisfaction of an investor for each contract with the next transaction price as a variable;
create a total dissatisfaction function for all contracts on the basis of the dissatisfaction function created for each contract; and
determine the next transaction price on the basis of a value of the created total dissatisfaction function.

11. The information processing device according to claim 10, wherein the dissatisfaction function is a sum of a square of the difference between the acquired selling limit and the next transaction price and a square of the difference between the next transaction price and the acquired buying limit.

12. The information processing device according to claim 10, wherein, in a processing to determine the next transaction price, a value that minimizes the value of the total dissatisfaction function is set as the next transaction price.
